(19) United States
(12) Patent Application Publication
(10) Pub. No.: US 2024/0370706 A1
(43) Pub. Date: Nov. 7, 2024

(54) CONTEXTUAL CONVOLUTION BLOCKS

(71) Applicant: Google LLC, Mountain View, CA (US)

(72) Inventors: David Marwood, Sunnyvale, CA (US); Shumeet Baluja, La Jolla, CA (US)

(21) Appl. No.: 18/690,176

(22) PCT Filed: Oct. 1, 2021
(86) PCT No.: PCT/US2021/053248

§ 371 Date: Mar. 7, 2024

(51) Int. Cl. G06N 3/0464

(52) U.S. Cl. CPC G06N 3/0464

(57) ABSTRACT

Methods, systems, and apparatus, including computer programs encoded on computer storage media, for processing an input through each of a plurality of layers of a neural network to generate an output, wherein the plurality of layers comprise a convolutional layer. One of the methods includes: receiving a layer input for the convolutional layer; processing the layer input to generate a layer output for the convolutional layer, comprising determining a convolution between the layer input and a filter associated with the convolutional layer; generating a spatial weight mask for the convolutional layer by using a contextual convolution block in accordance with a set of one or more spatially sensitive mask functions defined in the contextual convolution block; and determining a weighted layer output for the convolutional layer, comprising determining a product between the spatial weight mask and the layer output of the convolutional layer.

### BACKGROUND

This specification relates to processing inputs through the layers of a neural network to generate outputs.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that implements and trains a convolutional neural network that can perform a machine learning task on one or more received inputs. Depending on the task, the convolutional neural network can be configured to receive any kind of digital data input and to generate any kind of score, classification, or regression output based on the input.

In general, one innovative aspect of the subject matter described in this specification can be embodied in methods for processing an input through each of a plurality of layers of a neural network to generate an output, wherein the plurality of layers comprise a convolutional layer, and wherein the method comprises: receiving a layer input for the convolutional layer; processing the layer input to generate a layer output for the convolutional layer, comprising determining a convolution between the layer input and a filter associated with the convolutional layer; generating a spatial weight mask for the convolutional layer by using a contextual convolution block in accordance with a set of one or more spatially sensitive mask functions defined in the contextual convolution block; and determining a weighted layer output for the convolutional layer, comprising determining a product between the spatial weight mask and the layer output of the convolutional layer.

The convolutional layer may comprise a 2D convolutional layer; and the set of one or more spatially sensitive mask functions may be defined with respect to a horizontal axis and a vertical axis.

The set of one or more spatially sensitive mask functions may comprise one or more of a linear function, a sinusoidal function, comprising a 2D sinusoidal function, or a Gaussian function, comprising a 2D Gaussian function.

Each spatially sensitive mask function in the set of one or more spatially sensitive mask functions may include one or more mask coefficients, and wherein current values of the one or more mask coefficients may be dependent on trained values of block parameters of the contextual convolution block.

Using the contextual convolution block in accordance with the set of one or more spatially sensitive mask functions defined in the contextual convolution block may comprise computing the set of one or more spatially sensitive mask functions in accordance with the current values of the one or more mask coefficients.

The spatially sensitive mask function may comprise a non-zero constant.

Generating the spatial weight mask for the convolutional layer may comprise using the contextual convolution block to process the layer output for the convolutional layer in accordance with the set of one or more spatially sensitive mask functions.

The input may comprise vision data, and the neural network may be configured to perform a perception task on the vision data to generate the output.

The vision data may comprise an image, and the perception task may comprise one or more of an object detection task, an image classification task, a semantic segmentation task, or an image generation task.

The vision data may comprise a video, and the perception task may comprise one or more of a video processing task or a motion analysis task.

The method may further comprise training the neural network to determine trained values of network parameters of the neural network and the trained values of the block parameters of the contextual convolution block.

Other embodiments of this aspect include corresponding computer systems, apparatus, and computer programs recorded on one or more computer storage devices, each configured to perform the actions of the methods. A system of one or more computers can be configured to perform particular operations or actions by virtue of software, firmware, hardware, or any combination thereof installed on the system that in operation may cause the system to perform the actions. One or more computer programs can be configured to perform particular operations or actions by virtue of including instructions that, when executed by data processing apparatus, cause the apparatus to perform the actions.

The neural network is referred to as a convolutional neural network because the neural network includes one or more convolutional layers, e.g., in additional to one or more other layers that are of different types. The multiple layers included in the convolutional neural network are arranged in a sequence from a lowest layer in the sequence to a highest layer in the sequence. Each of the layers of the convolutional neural network is configured to receive a respective layer input and process the layer input to generate a respective layer output from the input. For example, the convolutional layer is a layer that has a filter and that computes linear transformations of its input using the filter to generate a convolutional layer output which may be referred to as a feature map. The neural network layers collectively process neural network inputs received by the neural network to generate a respective neural network output for each received neural network input.

At least one of the convolutional layers included in the neural network is a convolutional layer that is associated with a contextual convolution block. The contextual convolution block generates a layer-specific, spatial weight mask to be applied to an input, an output, or both of the convolutional layer based on computing a set of one or more spatially sensitive mask functions. The contextual convolution block has a set of trainable block parameters that generally determine the respective values of one or more coefficients of the set of one or more spatially sensitive mask functions. In the case of being applied to the output of the convolutional layer, the convolutional layer output, once augmented using the layer-specific weight mask, are then processed by a subsequent layer in the sequence. These features and other features are described in more detail below.

The subject matter described in this specification can be implemented in particular embodiments so as to realize one or more of the following advantages.

Using techniques described in this specification, a system can implement the operations of a neural network that includes one or more contextual convolution blocks that allow the creation of spatially specialized feature detectors that are translation invariant within a learned region in input data. In particular, the contextual convolution blocks can allow for the neural network to emphasize filters in specific portions of the input data such as distinct regions of an image, thereby increasing the expressive power of the network beyond standard convolutional layers.

Techniques described in this specification can incorporate spatial information in a manner which provides program performance improvements such as faster execution time and reduced memory requirements compared to other systems, while also maintaining translation invariance of convolutional layers.

This also makes the learning problem simpler, thereby providing a learning-efficient manner for incorporating spatial information with convolutional neural networks without resorting to the parameter inefficiencies associated with fully connected layers. Training of the neural network may require fewer computational resources, e.g. reduced processor cycles, reduced wall clock time, reduced power consumption, and the computational efficiency of training is therefore improved.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of a convolutional neural network system.

FIG. 2A is an illustration of operations performed by a standard convolutional layer.

FIG. 2B is an illustration of generating an input-dependent spatial weight mask for a convolutional layer by using a contextual convolution block.

FIG. 3 is an illustration of generating an input-independent spatial weight mask for a convolutional layer by using another contextual convolution block.

FIG. 4 is a flow diagram of an example process for generating a weighted layer output for a convolutional layer.

Like reference numbers and designations in the various drawings indicate like elements.

### DETAILED DESCRIPTION

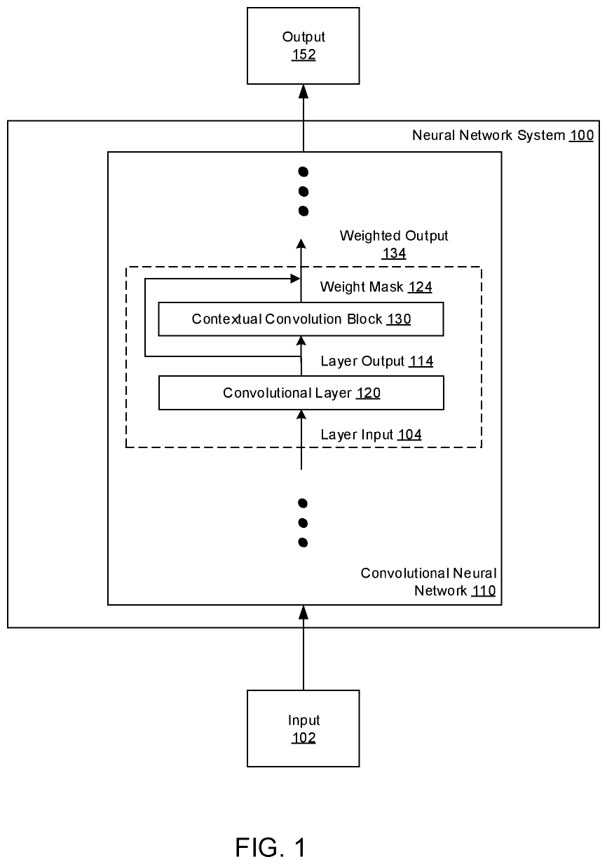

FIG. 1 shows an example neural network system 100. The neural network system 100 is an example of a system implemented as computer programs on one or more computers in one or more locations, in which the systems, components, and techniques described below can be implemented.

The neural network system 100 can receive an input 102 and perform a machine learning task on the input 102 based on processing the input 102 using a convolutional neural network 110 to generate an output 152 for the machine learning task. Depending on the task, the neural network system 100 can be configured to receive any kind of digital data input and to generate any kind of score, classification, or regression output based on the input. For example, the convolutional neural network can be configured to perform an image processing task, e.g., to receive an input comprising image data which includes a plurality of pixels. In this specification, processing an input image refers to processing the intensity values of the pixels of the image using a neural network. The image data may for example comprise one or more images or features that have been extracted from one or more images. The convolutional neural network can be configured to process the image data to generate an output for the image processing task.

For example, if the task is image classification, the outputs generated by the convolutional neural network for a given image may be scores for each of a set of object categories, with each score representing an estimated likelihood that the image contains an image of an object belonging to the category.

As another example, if the task is object detection, the outputs generated by the convolutional neural network for a given image may be one or more bounding boxes each associated with respective scores, with each bounding box representing an estimated location in the image and the respective score representing an estimated likelihood that an object is depicted at the location in the image, i.e., within the bounding box.

As another example, if the task is semantic segmentation, the outputs generated by the convolutional neural network for a given image may be labels for each of a plurality of pixels in the image, with each pixel being labeled as belonging to one of a set of object categories. Alternatively, the outputs can be, for each of the plurality of pixels, a set of scores that includes a respective score for each of the set of object categories that represents the likelihood that the pixel belongs to an object from the object category.

As another example, if the inputs to the convolutional neural network are Internet resources (e.g., web pages), documents, or portions of documents or features extracted from Internet resources, documents, or portions of documents, the outputs generated by the convolutional neural network for a given Internet resource, document, or portion of a document may be a score for each of a set of topics, with each score representing an estimated likelihood that the Internet resource, document, or document portion is about the topic.

As another example, if the inputs to the convolutional neural network are features of an impression context for a particular advertisement, the output generated by the convolutional neural network may be a score that represents an estimated likelihood that the particular advertisement will be clicked on.

As another example, if the inputs to the convolutional neural network are features of a personalized recommendation for a user, e.g., features characterizing the context for the recommendation, e.g., features characterizing previous actions taken by the user, the outputs generated by the convolutional neural network may be a score for each of a set of content items, with each score representing an estimated likelihood that the user will respond favorably to being recommended the content item.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

For example, the task can be a text to speech task, where the input is text in a natural language or features of text in a natural language and the network output is a spectrogram, a waveform, or other data defining audio of the text being spoken in the natural language.

As another example, if the input to the convolutional neural network is a sequence of text in one language, the output generated by the convolutional neural network may be a score for each of a set of pieces of text in another language, with each score representing an estimated likelihood that the piece of text in the other language is a proper translation of the input text into the other language.

As another example, if the input to the convolutional neural network is a sequence representing a spoken utterance, the output generated by the convolutional neural network may be a score for each of a set of pieces of text, each score representing an estimated likelihood that the piece of text is the correct transcript for the utterance.

As another example, the task can be a text generation task, where the input is a sequence of text, and the output is another sequence of text, e.g., a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an image generation task which seeks to generate images from the same distribution as the images on which the neural network system was trained. For image generation, the input may be a conditioning input and the output may be a sequence of intensity value inputs for the pixels of an image

As another example, the task can be a computer vision task, where the input is an image or a point cloud and the output is a computer vision output for the image or point cloud, e.g., a classification output that includes a respective score for each of a plurality of categories, with each score representing the likelihood that the image or point cloud includes an object belonging to the category. When the input is an image or point cloud, the convolutional neural network can include an embedding subnetwork that generates a respective embedding for each multiple patches of the image or point cloud, and the input to the first block of the convolutional neural network can be a sequence that includes the respective embeddings (and, optionally, one or more additional embeddings, e.g., at a predetermined position that will later be used to generate the output). Each patch includes the intensity values of the pixels in a different region of the input image.

As another example, the task can be a video processing task or a motion analysis task, where the input includes one or more video frames and the output is a video processing output, e.g., one or more modified video frames or one or more predicted next video frames of the input video frames, or a motion analysis output, e.g., an detection, tracking, identification output or an output specifying the general understanding of the behavior of an object that is present in the sequence of input video frames.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

The convolutional neural network 110 includes multiple neural network layers arranged in a predetermined sequence, at least one of which is a convolutional neural network layer, e.g., convolutional neural network layer 120. The convolutional neural network layer 120 may be included at various locations in the sequence of neural network layers and, in some implementations, multiple convolutional neural network layers may be included in the sequence.

A convolutional neural network layer is a layer in which the values of the layer output are calculated based on applying a filter (or kernel), e.g., a two-dimensional filter in square shape, to a subset of the values of the convolutional layer input. For example, the convolutional layer input can be generated by a preceding layer of the convolutional layer in the sequence of multiple neural network layers. Typically, the same filter is used to calculate each value of the convolutional layer output, by sliding the filter over different subsets of the convolutional layer input values. Each subset is convolved, that is, multiplied and summed by the filter.

In particular, at least one of the convolutional layers, e.g., convolutional neural network layer 120, is associated with a contextual convolution block, e.g., contextual convolution block 130. The contextual convolution block generates a layer-specific, spatial weight mask to be applied to an input, an output, or both of the convolutional layer based on computing a set of spatially sensitive mask functions. The contextual convolution block has a set of trainable block parameters that generally determine the respective values of one or more coefficients of the set of spatially sensitive mask functions. In the case where the convolutional layer is a 2D convolutional layer with a 2D filter, the set of one or more spatially sensitive mask functions used in the contextual convolution block can similarly be two-dimensionally defined, e.g., can include one or more spatially sensitive mask functions defined with respect to a horizontal axis and a vertical axis of the block input.

The convolutional neural network 110 can have any appropriate architecture that includes one or more convolutional layers that are each associated with a respective contextual convolution block.

In one example, as illustrated in FIG. 1, the convolutional neural network 110 can include a contextual convolution block 130 that is arranged subsequent to the convolutional layer 120. The contextual convolution block 130 is configured to receive as input the layer output 114 of the convolutional layer 120 and to generate as output a spatial weight mask 124. The contextual convolution block 130 includes a stack of hidden layers that collectively computes a sequence of transformations and runs a set of one or more spatially sensitive mask functions over data values included in (or derived from) the block input. The operations performed by the stack of hidden layers effectively compute “soft attention” on the spatial dimension, the channel dimension, or both of the block input. The convolutional neural network 110 can also include a shortcut (“residual”) connection between the block input (i.e., layer output 114) and the block output (i.e., the weight mask 124). The convolutional neural network 110 augments the layer output 114 using the spatial weight mask 124, e.g., by element-wise multiplying the layer output 114 with the spatial weight mask 124, so as to generate a weighted layer output 134 that can then be provided as input to a subsequent layer in the sequence.

In another example, the contextual convolution block 130 can be configured to generate a spatial weight mask 124 that is independent of the layer output 114, i.e., to generate as output the spatial weight mask 124 without receiving and processing the layer output 114 of the convolutional layer 120. Instead, during inference, the convolutional neural network 110 can use the contextual convolution block 130 in accordance with the trained values of the block parameters to generate a fixed, input-independent weight mask 124 to be applied to the layer output 114 to generate the weighted layer output 134.

In yet another example, the convolutional neural network 110 can include a contextual convolution block 130 that is arranged preceding to the convolutional layer 120. The contextual convolution block 130 is configured to receive as input the layer input 104 of the convolutional layer 120 and to generate as output a spatial weight mask 124. The convolutional neural network 110 augments the layer input 104 using the spatial weight mask 124, e.g., by element-wise multiplying the layer input 104 with the spatial weight mask 124, so as to generate a weighted layer input that can then be provided as input to the convolutional layer 120. The convolutional layer 120 then processes the weighted layer input to generate an output of the convolutional layer 120.

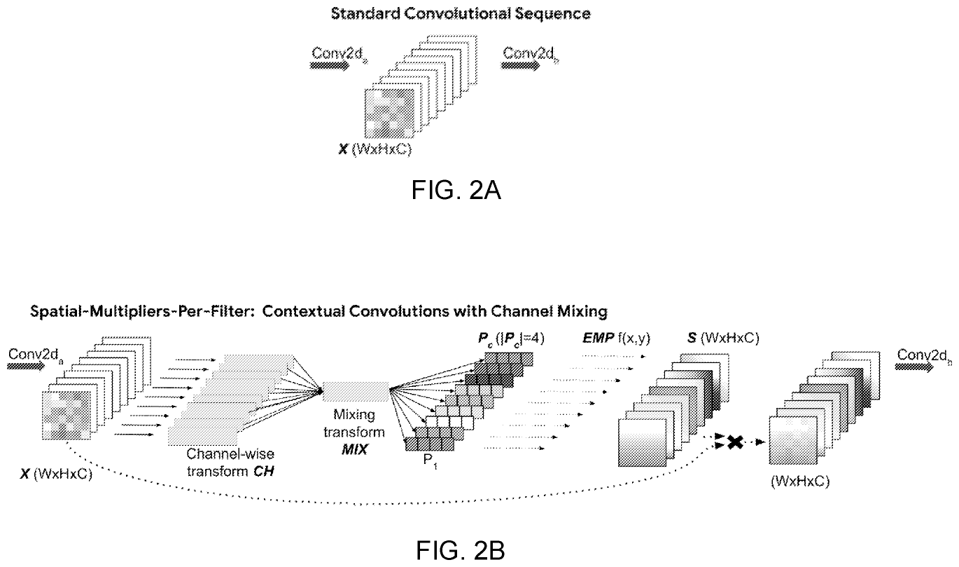

The details of the operations performed by the stack of hidden layers included in the contextual convolution block will be described in more detail below with reference to FIG. 2B, but in general, the contextual convolution block facilitates the creation of spatially specialized feature detectors that are translation invariant within a learned region. This increases the expressive power of the neural network beyond standard convolutional layers and allows learning unique filters for distinct regions of the input. In particular, the filters of the convolutional layers no longer need to be discriminative with respect to the layer inputs that are not likely to be found in their intended application area.

The convolutional neural network 110 can be trained on multiple batches of training inputs in order to determine trained values of the parameters of the neural network layers, and to determine trained values of the block parameters of the contextual convolution block(s) which include the parameters of the hidden layers included therein. For example, during the training, the neural network system 100 can process a batch of training inputs and generate a respective neural network output for each training input in the batch. The neural network outputs can then be used to adjust the values of the parameters of the components of the convolutional neural network 110, for example, through gradient descent and back-propagation neural network training techniques.

Once the convolutional neural network 110 has been trained, the neural network system 100 may receive a new neural network input for processing and process the neural network input through the neural network layers to generate a new neural network output for the input in accordance with the trained values of the parameters of the components of the convolutional neural network 110.

For convenience, this specification largely describes the neural network as a convolutional neural network. It should be noted that, however, the neural network need not be “convolutional” in order for the described techniques to work. That is, the described techniques can be similarly applied to neural networks having different architectures, e.g., networks that include one or more spatial layers, one or more time-varying layers, or both in place of or in addition to the convolutional layers.

A spatial layer generally refers to any neural network layer that operates on a layer input that contains spatial context information but isn't already spatially sensitive. As one example, the spatial layer can be a “pixel-squared layer” that is configured to receive as input an image and, for each pixel in that image, to apply a non-linear operation on the pixel value to generate as output the squared value of that pixel value. Another example of the spatial layer can be a “multi-scale layer” that is configured to receive as input an image or a spectrogram of some audio and to generate as output a multiply downscaled version of that input (e.g., a 2× downscaled image or audio, a 4× downscaled image or audio, etc.).

A time-varying layers generally refers to any neural network layer that is applied to a time-varying dimension but isn't already temporally selective. Examples of such layers can include recurrent layers such as long short-term memory (LSTM) layers or gated recurrent units (GRU) layers that may be used by a video or audio data processing system.

FIG. 2A is an illustration of operations performed by a standard convolutional layer.

FIG. 2B is an illustration of generating an input-dependent spatial weight mask for a convolutional layer by using a contextual convolution block.

In the example of FIG. 2B, the contextual convolution block is arranged subsequent to a 2D convolutional layer and is configured to receive as input the convolutional layer output “Conv2dₐ” and to generate as output a spatial weight mask to be applied to the convolutional layer output to generate the weighted convolutional layer output “Conv2d_{b}”.

The block input (i.e., the convolutional layer output) can include a height, width, and channel dimension, e.g., similar to an image. As depicted, the block input “Conv2dₐ” is a [H, W, C] tensor, where [H, W] represents the height and width dimensions and C represents the channel dimension. A tensor is a multidimensional array of numeric or other values, e.g., strings, having a specific order that corresponds to the dimensionality of the array. While the spatial and channel dimensions are relatively small in the example of FIG. 2B for ease of illustration, the block input can have much larger spatial and channel dimensions in practice.

The contextual convolution block includes a stack of hidden layers that collectively compute soft attention on both the spatial and channel dimensions of the block input.

In particular, as depicted in FIG. 2B, “Spatial-Multipliers-Per-Filter: Contextual Convolutions with Channel Mixing,” the contextual convolution block can include a first hidden layer (a “channel-wise transformation CH layer”) that applies a channel-wise transformation CH to the block input in accordance with current parameter values of the channel-wise transformation layer. That is, for each channel in the block input, the channel-wise transformation layer applies a respective transformation to the input value at each position in the channel to generate a transformed input value at each position in the channel-wise transformation layer output. This is used to re-calibrate each channel.

For example, the channel-wise transformation layer, which is configured as a pooling layer, can repeatedly apply a pooling function (e.g., a max pooling function or an average pooling function) to the input values in each channel, and the channel-wise transformation layer output may include a vector that includes one or more output values for each channel. As another example, the channel-wise transformation layer can include a fully-connected layer (or a different fully-connected layer for each channel in the block input) that operates on the input values in each channel to generate the layer output. As yet another example, the channel-wise transformation layer can include two or more fully-connected layers that are separated by a rectified linear activation (ReLU) layer or some other activation layers. Most importantly, in any above example, when generating the layer output for each single channel, the channel-wise transformation layer operates only on the input values in that channel and so the information contained within each channel is transformed independently from one another.

In some cases, the contextual convolution block can include an optional hidden layer (a “downsampling layer”) that applies a channel-wise downsampling operation to the block input before any processing. The downsampling layer, when included, can be arranged preceding to the channel-wise transformation layer. The downsampling layer resizes each channel in the block input to have a different, e.g., smaller, dimension, and thereby ensures parameter efficiency of the contextual convolution block.

The contextual convolution block can also include a second hidden layer (a “mixing transformation MIX layer”) that can be arranged subsequent to the channel-wise transformation layer and that applies a mixing transformation MIX to the output of the channel-wise transformation layer in accordance with current parameter values of the mixing transformation layer. The mixing transformation layer applies a respective transformation to the transformed input value at each position in the channel-wise transformation layer output to generate a mixed input value at each position in the mixing transformation layer output. The mixing transformation effectuates information sharing across different channels in the block input. For example, the mixing transformation layer can be a fully-connected layer configured to receive as layer input the layer output from the channel-wise transformation layer (that, as described earlier, includes one or more output values for each channel) and to generate as output (e.g., in the format of a vector) one or more EMP values P_{c,1} . . . , P_{c,n} for each channel c in the block input, where n may be any integer value greater than or equal to one.

Lastly, the contextual convolution block can include a third hidden layer (an “excitation map producer EMP layer”) that applies a sequence of functions over the input values across different channels in accordance with current parameter values of the excitation map producer layer to generate as block output a spatial weight mask from which a weighted convolutional layer output can be determined. Similar to the channel-wise transformation layer, the excitation map producer layer operates in a channel-wise manner. Some examples of the excitation map producer layers are described next.

In particular, the input to the excitation map producer layer may include one or more input-dependent EMP values P_{c,1} . . . , P_{c,n} for each channel c, where n is a fixed number. The excitation map producer layer can use the EMP values to generate a spatial weight mask S which in turn includes a spatial excitation map for each channel. As depicted, the spatial weight mask S has the dimension of [H, W, C], where [H, W] is the dimension of each spatial excitation map. This allows for the contextual convolution block to determine where spatially each channel is important, i.e., in addition to determining the importance of each channel. The fixed number n is smaller, and usually much smaller, than the size of a channel-wise block input H×W. For example, the fixed number can be one. As another example, the fixed number can be four, while is channel-wise block input is a 32×32 matrix.

For each channel in the block input, the EMP layer then uses a set of one or more spatially sensitive mask functions that are parameterized (i.e., defined) by the EMP values P_{c} to generate the spatial excitation map for the channel. That is, the EMP layer uses the EMP values as the current values of the coefficients of the spatially sensitive mask function(s) and then runs the spatially sensitive mask function(s) over the input values, data values derived from the input values (e.g., the respective data position of each input value), or both in each channel in the block input.

The spatially sensitive mask function can be any of a variety of low-coefficient, differentiable functions. For example, the EMP layer can apply a set of one or more linear functions, sinusoidal functions (including 2D sinusoidal function), or Gaussian functions (including 2D Gaussian functions) that are parameterized by the EMP values to the input values, data values derived from the input values, or both in each channel. Moreover, a small non-zero constant value may be added to the mask function so that the no value in the spatial excitation map goes completely to zero. This can stabilize training.

For example, the set of one or more spatially sensitive mask functions can be mathematically defined as a bilinear interpolation function:

$${f}_{c} ( x , y ) = ( {initial}_{c}^{w} \times ( W - x ) / W + {end}_{c}^{w} \times s / W ) \times ( {initial}_{c}^{h} \times ( H - y ) / H + {end}_{c}^{h} \times y / H ) ,$$

where the four EMP values P_{c}={initial_{c}^{w}, end_{c}^{w}, initial_{c}^{h}, end_{c}^{h}}, with W, H, x, y representing the channel width, channel height, horizontal position of each input value in the channel, and vertical position of each input value in the channel, respectively. In this example, the spatially sensitive mask function can create a smooth two dimensional gradient over the input channel.

As another example, the set of one or more spatially sensitive mask functions can be a 2D sinusoidal or a 2D Gaussian function, the mathematical definition of which are provided below in Table. 1.

TABLE 1

| Function | Inputs P_{c} | f_{c}(x, y) |
|---|---|---|
| 2D-Gaussian | {μ_{c}^{w}, σ_{c}^{w}, μ_{c}^{h}, σ_{c}^{h}} | (G(x\|μ_{c}^{w}, σ_{c}^{w}) + 0.5) * |
| | | (G(y\|μ_{c}^{h}, σ_{c}^{h}) + 0.5) |
| 2D-Sine | {ν_{c}^{w}, Φ_{c}^{w}, ν_{c}^{h}, Φ_{c}^{h}} | (sin(ν_{c}^{w} × x + Φ_{c}^{w})/2 + 1) * |
| | | (sin(ν_{c}^{h} × y + Φ_{c}^{h})/2 + 1) |

The result of the sequence of operations performed by the channel-wise transformation CH layer, the optional mixing transformation MIX layer, and the excitation map producer EMP layer, which may be mathematically computed as

S(X)=EMP·MIX·CH(X), is then element-wise multiplied by the block input (i.e., the output of the convolutional layer) to generate the weighted convolutional layer output CC-block (X)=S(X)×X=EMP·MIX·CH(X)×X where X∈ [symbol] H×W×C is the block input.

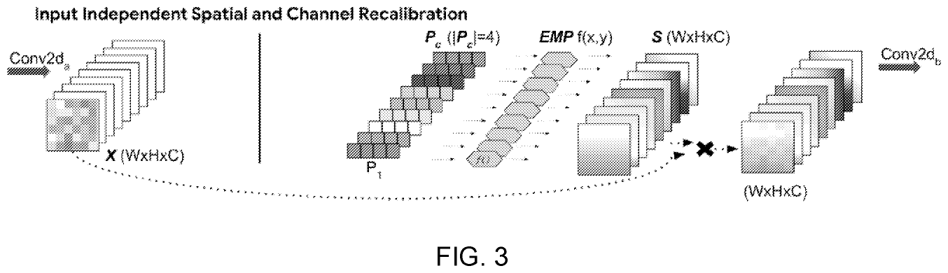

FIG. 3 is an illustration of generating an input-independent spatial weight mask for a convolutional layer by using a contextual convolution block.

As depicted in FIG. 3, “Input Independent Spatial and Cannel Recalibration,” the contextual convolution block is configured to generate as output a spatial weight mask without receiving or processing the convolutional layer output “Conv2dₐ”. The spatial weight mask S, which similarly include a spatial excitation map for each channel, is then applied to the convolutional layer output to generate the weighted convolutional layer output “Conv2d_{b}”.

In particular, the contextual convolution block can generate the spatial excitation maps that similarly retain the spatial and channel excitation but are independent of the block input (i.e., convolutional layer output). Mathematically, the contextual convolution block can generate the weighted layer output by element-wise multiplying the spatial weight mask S=EMP with the output of the convolutional layer: CC-block(X)=EMP×X.

Similar to the example of FIG. 2B, the EMP layer can use a set of one or more spatially sensitive mask functions that are parameterized by the EMP values P_{c} to generate the spatial excitation map for the channel. In this example, however, the coefficients P_{c} of the set of one or more spatially sensitive mask functions are directly defined by the learnable block parameters, rather than determined as a result of operations performed on the block input by other hidden layers included in the contextual convolution block as in the example of FIG. 2B. Since the spatial excitation maps have no dependence on X, the spatial weight mask S, which in turn includes the spatial excitation maps, is constant at inference time.

Note that in either above case, it is very unlike the standard convolution operation as depicted in FIG. 2A “Standard Convolutional Sequence,” where the output of a convolutional layer is immediately provided to a subsequent layer without any modification. It is also very unlike other existing techniques used to augment convolution operations. For example, some existing augmentation techniques employ a stack of one or more pooling layers and one or more fully-connected layers with ReLU and Sigmoid activations. But they are neither spatially sensitive (or selective) nor parameter efficient.

Specifically, these existing techniques are not spatially sensitive because the non-learned global average pool operation intentionally drops any spatial information which may nevertheless be helpful. Let us consider the example machine learning task of face recognition with pre-aligned faces. A typical feature detector to emerge in a neural network system configured to perform the task is one that detects eyes. However, when such a translation-invariant detector is applied across the entire image, the shape will also trigger on various poses of the mouth. Therefore, in a neural network system that merely implements standard convolution operations, the actual detector developed must be good at both recognizing eyes and not triggering false positives on mouths. By adding contextual convolution block and simultaneously learning spatial excitation maps per channel, the neural network system can learn the specific portion of an image to which a filter should be applied. With this added expressiveness, specific filters, such as the eye detector, can be weighted more heavily in the top half of the image. This makes the learning problem simpler, even when the mechanisms at inference are input-independent. Such a need for spatial sensitivity may also be found in a variety of vision tasks in which the image may not be pre-aligned. For example, in many image processing tasks including image classification, object detection, semantic segmentation, and image generation tasks, visual elements such as blue skies, green grass, pavement, etc., have strong spatial priors that can be easily exploited by using the described techniques in order to improve overall neural network system performance on these tasks.

These existing techniques are also not parameter efficient because to generate an output of a fully-connected layer, each value in the layer output is a calculated as an independently adjusted weighted combination of each value in the layer input and a corresponding fully-connected layer parameter value. By contrast, the described techniques uses the set of one or more spatially sensitive mask functions which are parameterized by a much smaller number of block parameters to calculate each value in the EMP layer output. Accordingly, because there are far fewer parameters in the EMP layer, training and using an EMP layer may require less memory, processor cycles, and time than would an equivalent fully-connected layer.

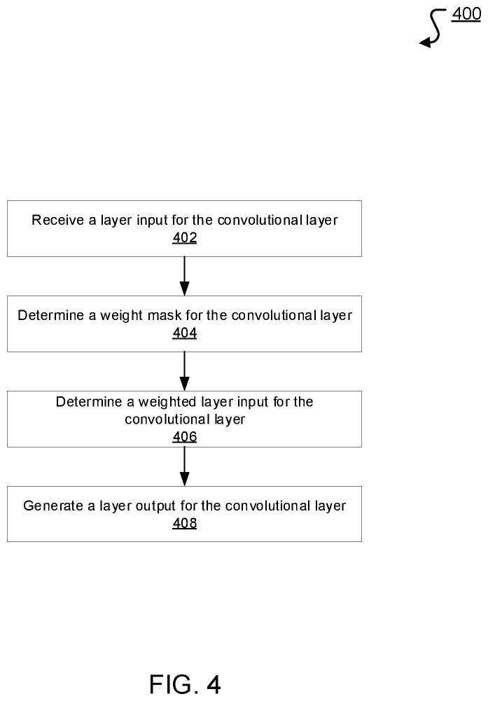

FIG. 4 is a flow diagram of an example process 400 for generating a weighted layer output for a convolutional layer. For convenience, the process 400 will be described as being performed by a system of one or more computers located in one or more locations. For example, a neural network system, e.g., neural network system 100 of FIG. 1, appropriately programmed in accordance with this specification, can perform the process 400.

The system receives a layer input for the convolutional layer (step 402).

The system processes the layer input to generate a layer output for the convolutional layer (step 404). The layer output can have the form of a tensor with three dimensions-width, height, and channel dimension. The system can generate the layer output based on computing a convolution between the layer input and a filter associated with the convolutional layer, in accordance with current values of the parameters of the filter.

The system generates a spatial weight mask for the convolutional layer by using a contextual convolution block (step 406) in accordance with current values of the block parameters of the contextual convolution block.

In general, the spatial weight mask can include a spatial excitation map for each channel in the layer output. The spatial excitation map may have the same spatial dimensions as the layer output. To generate a spatial excitation map for each channel in the layer output, the system processes the layer output, data derived from the layer output, or both in accordance with a set of one or more spatially sensitive mask functions defined in the contextual convolution block. In particular, each spatially sensitive mask function has one or more mask coefficients, and the current values of the one or more mask coefficients are determined as a result of processing the layer output using one or more hidden layers of the contextual convolution block in accordance the current values of parameters of the hidden layers. This has been described in more detail above with reference to FIG. 2B.

The system determines a weighted layer output for the convolutional layer (step 408) based on element-wise multiplying the spatial weight mask and the layer output of the convolutional layer.

The process 400 can be performed as part of predicting an output for an input for which the desired output, i.e., the output that should be generated by the system for the input, is not known.

The process 400 can also be performed as part of processing inputs derived from a set of training data, i.e., inputs derived from a set of inputs for which the output that should be generated by the system is known, in order to train the convolutional neural network to determine trained values for the parameters of the convolutional neural network and to determine trained values for the block parameters of the contextual convolution block(s) which include the parameters of the hidden layers included therein.

The system can repeatedly perform the process 400 on training inputs selected from a set of training data as part of a conventional machine learning training technique to train the neural network layers and the hidden layers included in the contextual convolution block(s) of the convolutional neural network, e.g., a gradient descent with backpropagation training technique that uses a conventional optimizer, e.g., stochastic gradient descent, RMSprop, or Adam optimizer, to optimize an objective function that is appropriate for the machine learning task that the convolutional neural network is configured to perform.

During training, the system can incorporate any number of techniques to improve the speed, the effectiveness, or both of the training process. For example, the system can use dropout, label smoothing, or both to reduce overfitting. As another example, the system can perform the training using a distributed architecture that trains multiple instances of the convolutional neural network in parallel. Moreover, the system can first pre-train the convolutional neural network on a large unsupervised or weakly supervised data set through unsupervised learning, e.g., to minimize an unsupervised or a weakly supervised loss, and then fine-tune the convolutional neural network on task-specific training data to optimize the objective function for the machine learning task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for processing an input through each of a plurality of layers of a neural network to generate an output, wherein the plurality of layers comprise a convolutional layer, and wherein the method comprises:
receiving a layer input for the convolutional layer;
processing the layer input to generate a layer output for the convolutional layer, comprising determining a convolution between the layer input and a filter associated with the convolutional layer;
generating a spatial weight mask for the convolutional layer by using a contextual convolution block in accordance with a set of one or more spatially sensitive mask functions defined in the contextual convolution block; and
determining a weighted layer output for the convolutional layer, comprising determining a product between the spatial weight mask and the layer output of the convolutional layer.

2. The method of claim 1, wherein:
the convolutional layer comprises a 2D convolutional layer; and
the set of one or more spatially sensitive mask functions are defined with respect to a horizontal axis and a vertical axis.

3. The method of claim 1, wherein the set of one or more spatially sensitive mask functions comprise one or more of a linear function, a sinusoidal function, comprising a 2D sinusoidal function, or a Gaussian function, comprising a 2D Gaussian function.

4. The method of claim 1, wherein each spatially sensitive mask function in the set of one or more spatially sensitive mask functions includes one or more mask coefficients, and wherein current values of the one or more mask coefficients are dependent on trained values of block parameters of the contextual convolution block.

5. The method of claim 4, wherein using the contextual convolution block in accordance with the set of one or more spatially sensitive mask functions defined in the contextual convolution block comprises computing the set of one or more spatially sensitive mask functions in accordance with the current values of the one or more mask coefficients.

6. The method of claim 1, wherein the spatially sensitive mask function comprises a non-zero constant.

7. The method of claim 1, wherein generating the spatial weight mask for the convolutional layer comprises using the contextual convolution block to process data derived from the layer output for the convolutional layer in accordance with the set of one or more spatially sensitive mask functions.

8. The method of claim 1, wherein the input comprises vision data, and the neural network is configured to perform a perception task on the vision data to generate the output.

9. The method of claim 8, wherein the vision data comprises an image, and the perception task comprises one or more of an object detection task, an image classification task, or a semantic segmentation task.

10. The method of claim 8, wherein the vision data comprises a video, and the perception task comprises one or more of a video processing task or a motion analysis task.

11. The method of claim 1, further comprising training the neural network to determine trained values of network parameters of the neural network and the trained values of the block parameters of the contextual convolution block.

12. A system comprising one or more computers and one or more storage devices storing instructions that are operable, when executed by the one or more computers, to cause the one or more computers to perform the operations for processing an input through each of a plurality of layers of a neural network to generate an output, wherein the plurality of layers comprise a convolutional layer, and wherein the operations comprise:
receiving a layer input for the convolutional layer;
processing the layer input to generate a layer output for the convolutional layer, comprising determining a convolution between the layer input and a filter associated with the convolutional layer;
generating a spatial weight mask for the convolutional layer by using a contextual convolution block in accordance with a set of one or more spatially sensitive mask functions defined in the contextual convolution block; and
determining a weighted layer output for the convolutional layer, comprising determining a product between the spatial weight mask and the layer output of the convolutional layer.

13. A computer storage medium encoded with instructions that, when executed by one or more computers, cause the one or more computers to perform the operations for processing an input through each of a plurality of layers of a neural network to generate an output, wherein the plurality of layers comprise a convolutional layer, and wherein the operations comprise:
receiving a layer input for the convolutional layer;
processing the layer input to generate a layer output for the convolutional layer, comprising determining a convolution between the layer input and a filter associated with the convolutional layer;
generating a spatial weight mask for the convolutional layer by using a contextual convolution block in accordance with a set of one or more spatially sensitive mask functions defined in the contextual convolution block; and
determining a weighted layer output for the convolutional layer, comprising determining a product between the spatial weight mask and the layer output of the convolutional layer.
